(19) United States
(12) Patent Application Publication
(10) Pub. No.: US 2009/0169795 A1
(43) Pub. Date: Jul. 2, 2009

(54) Poster as well as methods and materials for its manufacture

(76) Inventor: Andre Fiechter, Hausen am Albis (CH)

Correspondence Address: KENYON & KENYON LLP, ONE BROADWAY, NEW YORK, NY, 10004, US

(21) Appl. No.: 12/005,496

(22) Filed: Dec. 26, 2007

(51) Int. Cl. B32B 33/00; B32B 3/10

(52) U.S. Cl. 428/41.8; 428/131

(57) ABSTRACT

An improved one-side transparent, on the other side image carrying, sheet material and intermediates, with improved through-vision properties. One exemplary embodiment is a poster material having a light absorbing coating with the first side of the poster material flattened by thermic forming. The poster material may also be woven from yarn having a light absorbing coating and fused at crossing points. The yarn may optionally have at least a first surface that is essentially flat.

### FIELD OF THE INVENTION

The present invention relates to an adhesion compound, which is appropriate for manufacturing graphical products, as well as such graphical products and a method for manufacturing such products.

### BACKGROUND OF THE INVENTION

One-side see through posters are already known. Such posters may be made of regularly punched foils or textiles. They can be adherent or non-adherent.

The disadvantage of adherent products is that the adhesive layer thereon has to be protected by a liner that will be disposed of at the application site, generating a considerable amount of waste. In addition, the adhesive must be strong enough to withstand mild vandalism, but simultaneously week enough to ensure complete removal upon replacement of the poster. In addition, the adhesive used must be clear and punchable without causing any distortions of the punched holes in order to ensure that the visual impression of the image or the through vision are not affected.

Non-adhesive and non-adherent posters, e.g., made of punched plastics or open work fabrics (also termed herein “holey textile”), with information printed on one side and the other side coated with a dark color, are also known.

The problem with such state of the art posters is their poor through vision quality. Investigations by the inventor suggest that the poor through vision quality might be caused by irregularities in the fabric and irregular “pollution” of the edges of the apertures/holes in the sheet. Aperture/hole edge pollution caused by image printing and/or application of the light absorbing dark color has proven difficult to avoid.

The use of a liner in order to protect the transport means of printing apparatuses has been proposed for punched sheets. However, although such liner provides some protection for the rear surface, the edges of the apertures/holes are still unprotected and subject to “pollution.” In addition, unless specific provisions are made with regard to the release properties of the adhesive fixing the liner, residues of the adhesive may remain on the rear side or even the holes of the poster, which is unacceptable for one-sided see through materials.

Thus, there is still a need for improved one-side transparent (see-through), on the other side image carrying, sheet material and intermediates, with improved through-vision properties.

### SUMMARY OF THE INVENTION

Reference throughout this specification to “one embodiment” or “an embodiment” or “an exemplary embodiment” or “an exemplary adhesion compound,” etc., means that a particular feature, structure, or characteristic described in connection with the embodiment is included in at least one embodiment of the present invention. Thus, the appearances of the phrases “in one embodiment” or “in an embodiment” or “in an exemplary embodiment,” etc., in various places throughout this specification are not necessarily all referring to the same embodiment. Furthermore, the particular features, structures, or characteristics may be combined in any suitable manner in one or more embodiments.

An exemplary adhesion compound of the present invention, for use in producing non-adhesive and non-adherent posters, includes at least a poster material with a poster substrate and a non-holey carrier material with a carrier substrate. As detailed below, the adhesion compound is manufactured so as to assure that the poster, on one side, exhibits, unique light absorbing properties, which significantly improve the see-through qualities of the poster. The discussion regarding the unique light absorbing properties of the poster follows after the discussion regarding the general make-up of the adhesion compound below.

An exemplary poster produced as described herein, printed on one side and that can be seen through from the other side, can be hung-up or put-up in a room in various ways, e.g., stabilized—if need be—by a frame or placed against a glass pane, or hung in a room without any additional stabilization.

In an exemplary embodiment of the present invention, the adhesion compound includes a poster material wherein the side facing the carrier material is the second side with a light absorbing surface. The first side of the poster material may have a printable surface. In another embodiment (that may also be a precursor of the before described embodiment), the first side of the poster material may have a surface that can be directly provided with an image receptive coating. Alternatively, the first side of the poster material may be provided with an image receptive coating after pre-treatment.

For connecting the poster material to the carrier material, the adhesion compound may be provided with an adhesive layer arranged between the poster material and the carrier material. The adhesive layer has a better adhesion to the carrier material than to the poster material such that after separating the poster material and the carrier material the adhesive layer remains on the carrier material.

In an exemplary embodiment, the poster material or poster of the present invention has no adhesive properties, including electrostatic or other adhesion properties, such as so called “cling” properties.

In an exemplary adhesion compound of the present invention, the holes are perforation holes or punching holes, respectively.

In one embodiment of an intermediate adhesion compound, the first side of the poster material has a first surface that is also light reflective. This light reflective surface may be provided by a light reflective poster material or by a light reflective coating/layer or by a light reflective print.

An exemplary method of the present invention is a material and cost saving method using specific adhesion compounds having in at least some steps a carrier material that does not have to be discharged but that can be used in other applications, e.g., a perforated carrier as a poster material for one-side see-through adhesive posters, and a non-perforated carrier as an adhesive poster for use on opaque surfaces. For example, the carrier material itself may be fixed, e.g., to windows, to display information. In this case, the carrier material has see-through properties and has a first side with a surface, which is printable or that can be provided with an image receptive coating directly or after pre-treatment, and a second side with a surface which is light absorbing. Similar to the first side of the poster material, the first side of the carrier material may have a surface which is light reflecting. Such light reflecting surface of the carrier material may be provided as described above in connection with the poster material.

In an exemplary embodiment of the adhesion compound, an adhesive layer may be arranged between the carrier material and the poster material and the light absorbing second side of the carrier material may face the poster material. The adhesive layer may have a better adhesion to the carrier material than to the poster material.

The poster material and the carrier material may in at least one area be provided with regularly distributed holes. The holes may be perforation holes or punching holes, respectively. Further, the holes may be identical and/or form a regularly repeating pattern of holes.

In another exemplary adhesion compound of the present invention, the carrier material has no holes. This is the case in an adhesion compound intermediate, e.g., prior to perforation or punching, respectively, or in an adhesion compound wherein after perforation or punching the perforated/punched carrier has been replaced by a protective carrier, e.g., without holes for protecting the light absorbing surface during the poster production steps during which the first side is provided with a light reflecting surface and/or indicia, e.g., information such as an image and/or text.

In a further exemplary adhesion compound of the present invention, the first side of the poster material is provided with indicia, e.g., an image and/or a text.

If the carrier shall not be disposed of, the first side of the carrier material of an exemplary adhesion compound may have a surface which is printable or which features an image receptive coating. The surface of the first side of the carrier material of such an adhesion compound can then be printed on with indicia. If such indicia provided carrier has no holes, for see-through applications it should be at least partially transparent. If not transparent, the applications may be on opaque surfaces.

In an exemplary embodiment of the adhesion compound, holes are provided in at least one area of the poster material, and optionally of the carrier material. The holes may be regularly (evenly) distributed holes and have a diameter, e.g., of 1 to 5 mm or 1 to 2 mm. The holes may account for, e.g., 30% to 60% or 30% to 50%, of the area provided with regularly distributed holes. In the case of punched holes, the holes are, e.g., round and may be identical.

As already briefly addressed above, the surface of the first side and/or the surface of the second side of the poster material and/or the surface of the first side and/or the surface of the second side of the carrier material may be light absorbing and/or light reflecting, respectively, e.g., due to at least one coating/layer applied to the respective side having the required light absorbing or light reflecting properties and/or due to dyeing of the poster substrate and/or of the carrier substrate. The poster material and/or carrier material may also be made from a light absorbing material.

In another exemplary embodiment of the adhesion compound, the poster substrate and/or the carrier substrate are a compound material, particularly a laminate. This or these compound material(s) can be selected such that they provide at least one of or both of the light reflecting or light absorbing surfaces.

Two or three of the above described approaches may be used, e.g., to provide one or more of the light absorbing or light reflecting surfaces by coating, others by dyeing and/or using compound material(s), and/or by using light absorbing materials for the poster material or carrier material and a light reflecting coating.

In exemplary embodiments of the inventive adhesion compound, the light reflecting surface of the first side of the poster material and/or the light reflecting surface of the first side of the carrier material appear white or metalized, and the light absorbing surface of the second side of the poster material and/or the light absorbing surface of the second side of the carrier material appear black. The metalized appearing surfaces may appear as such due to an aluminum layer/coating.

Exemplary poster materials suitable for use in adhesion compounds of the present invention include, e.g., materials provided with or containing light absorbingly colored paper or light absorbingly coated paper, light absorbing, colored plastic foils, synthetic foils provided with or containing a light absorbing coating, materials being or containing more than one layered compound fabric, such as paper and synthetic fabric, a compound fabric made of various synthetic fabrics, a compound made of paper and/or synthetic fabric and one or more further materials, pulp fabrics, and open work fabrics made of textile and/or synthetic fibers.

In an exemplary embodiment of the present invention, the poster material may be formed from a light absorbing mesh-like sheet, e.g., a textile woven from unifilar or multifilar yarns. The mesh-like sheet may be made from a yarn with at least a first surface that is flat. The mesh-like sheet may have a first surface that is as flat as possible, and a first surface of the mesh-like sheet material (facing away from the carrier material) may be provided with a light reflecting coating.

The use of a light absorbing substrate, especially in the case of a textile formed from yarns, was found to noticeably improve the see-through quality of a resulting poster. This improvement possibly may be attributed to the fact that by using a light absorbing substrate the walls surrounding/defining the holes (the edges of the holes) are predominantly also light absorbing.

The yarns may be secured or fused together at their crossings so as to prevent distortion of the apertures/holes upon subsequent manipulation of the fabric. Such distortion generates irregularities in the hole pattern, and thus, negatively affects the through-vision visual impression.

In a further exemplary embodiment, the surface of the first side of the poster material may be additionally flattened. As detailed further below, flattening of the poster material results in an “overhang” of the surface to be provided with a light reflective coating and/or image, and thus, reduces “pollution” of the holes/apertures with coating material.

A light absorbing mesh-like poster material, according to exemplary embodiments of the present invention, can be produced by several methods. Several exemplary methods are described below:

(i) A flat, fibrous, yarn (unifilar or multifilar) and/or fibrous material is woven and the woven mesh-like textile/sheet material is then light absorbingly coated, resulting in a light absorbing stabilized mesh-like material or textile. An example for the yarn material is nylon, optionally, in order to improve the stability and/or the flatness of the fabric, thermic forming, e.g., in a calender, may be applied to the woven material (prior to the coating or after the coating).

(ii) A thermoplastic yarn (unifilar or multifilar) is woven to give a mesh-like sheet material. This material may then be thermically formed, e.g., in a calender, to provide for at least a first flat surface of the resulting woven material. The thermic forming may fuse the yarns, e.g., at their crossing points. The yarn may be made from a light absorbing material and/or the mesh-like sheet material may be coated, e.g., on a side opposite the flat side, with a light absorbing material.

(iii) A yarn (unifilar or multifilar) having a thermoplastic coating is used to form, e.g., by weaving, a mesh-like sheet material. This material may then be thermally fused and formed, e.g., in a calender, to provide for at least a first flat surface of the resulting woven material. The thermic forming may fuse the yarns, e.g., at their crossing points. The thermoplastic coating may be made from a light absorbing material and/or the mesh-like sheet material may be coated, e.g., on a side opposite the flat side, with a light absorbing material. The yarn itself may also be made from a light absorbing material.

(iv) A light absorbing yarn, e.g., made from polyester, is woven to give a mesh-like sheet material. The yarn has a light absorbing thermoplastic coating that is sufficiently thick such that a thermo treatment after fabric formation, e.g., by weaving, results in a thermic fusion of overlapping yarns and in a flattening of a first surface of the woven material. Such treatment may be performed, e.g., in a calender, resulting in a yarn with a cross-section in form of, e.g., a 90° turned D or a half circle.

Dependent on whether the thermic forming is applied to only one side of the textile or to both sides of the textile with different intensity or to both sides of the textile with identical intensity, the hole size (for example, as can be seen in a transverse cross section of the poster material hole) may vary from tapered (thermic forming on one side only) to a form in which with the largest diameter is, e.g., in the center of the poster material or hole.

The light absorbing or light absorbingly coated textile formed in one of the above described methods may then on the first flat side be provided with indicia, such as text or an image. Alternatively, prior to providing the indicia, the first flat side may first be provided with a light reflecting coating using a coating material chosen, e.g., based on viscosity, so as to assure that coating material does not flow into the textile holes, i.e., the spaces defined by the woven yarns. The thickness of such light reflecting coating, for example, in case of 30 to 50% open area, may be 10 to 12 g/m². Exemplary coating methods suitable for applying the light reflecting coating include, e.g., cascade coating, rotogravior printing, flexo graphics printing, etc.

In an exemplary embodiment of the present invention, the holes may be plugged during application of the light reflecting coating material so as to prevent “pollution” of the holes. In the case of a material with tapered holes produced, e.g., by punching, a foil covered with protrusions or knobs matching the holes can be placed onto the second side of the poster substrate such that the knobs fill the holes. Due to the tapered shape, upon removal of the foil, no color from the light reflecting coating material will “pollute” or, in other words, be smeared onto the walls of the holes.

The poster materials may be made from a flame retardant material. In the case of a coated material, both the yarn and any coating may be flame retardant.

Exemplary carrier materials suitable for use in the adhesion compounds of the present invention include, e.g., carrier materials provided with or containing light absorbingly colored paper or light absorbingly coated paper, light absorbing colored plastic foils, synthetic foils provided with or containing a light absorbing coating, materials being or containing more than one layered compound fabric, such as paper and synthetic fabric, compound fabrics made of various synthetic fabrics, and compounds made of paper and/or synthetic fabric and one or more further materials.

In an exemplary embodiment of the present invention, the poster material and/or the carrier material are provided with at least one auxiliary coating on the second side of the poster material, such as a translucent separation/release layer and/or a protection layer, and are provided with an auxiliary layer on the first side of the poster material and/or the carrier material, which improves printability of the first side.

The inventive adhesion compound that has already been provided with information/indicia may have at least one additional layer over the information/indicia for improving the visual impression and/or the stability of the printed indicia. Exemplary layers are one or more protection layer(s) selected from the group comprising layers, e.g., having a high hardness, for improving the abrasion resistance, layers for enhancing the light fastness, e.g., having UV absorbants, layers for enhancing the weather fastness, layers for protection against graffiti, e.g., which demonstrate little or no absorption of spray paint solvents, and two or more layers of the same or different kind.

In a further exemplary embodiment of the present invention, the carrier material of the adhesion compound is a carrier substrate that is sticky on both sides. Both sides of such a carrier material may be covered with poster material, e.g., a hole containing poster material. Dependent on the production step, the carrier material may also have holes.

In an exemplary embodiment of the poster material, or such poster material comprising adhesion compound, the sum of all areas that are see-through from at least one side due to holes may range, e.g., from at least 50% to 100%.

In an adhesion compound of an exemplary embodiment of the present invention, neither the surface of the poster material intended for printing nor the opposite surface of the carrier material are sticky. This means that either the carrier material has only an adhesive layer on one surface, or—in the case of two adhesive layers—the carrier material is sandwiched between two poster materials with non-stick sides intended for indicia print directed away from the carrier.

The poster material may start off with a light reflecting first side. Alternatively, light reflecting properties may be subsequently applied to the poster material, e.g., during the indicia providing step. A poster material provided with information on the first side is also termed herein “poster.”

In an exemplary embodiment of the present invention, the adhesion compound may consist of or include perforated poster material with a light reflecting, e.g., white, first side, and a light absorbing, e.g., black, second side, a continuous carrier material, and an adhesive layer between the second side of the poster material and the carrier material, wherein the adhesive layer upon separating the poster material remains on the carrier material.

The adhesion compound can easily be printed by common printing equipment and separated from the carrier/liner material already at the printing site such that the carrier/liner material can easily be collected in large quantities for correct disposal, re-use, or recycling.

An exemplary adhesion compound for use in producing non-adhesive and non-adherent posters according to the present invention includes at least a poster material with a poster substrate, and a carrier material separably connected to the poster substrate by an adhesive layer. The poster material has on a second side a light absorbing surface. The adhesive layer has a better adhesion towards the carrier material than towards the poster material such that after separation of the poster material and the carrier material the adhesive layer remains on the carrier material. The side of the poster material facing the carrier material is the second side with the light absorbing surface. The poster material has holes extending from the second surface to the first surface, distributed one of regularly and in a regular pattern, such that in separated form it is see-through from the second side with the light absorbing surface. The hole size of a given hole at or adjacent the first surface is different than the hole size for the same hole at or adjacent the second surface.

The poster material may have on a first side a light reflecting surface, e.g., provided by a light reflecting coating. The poster substrate may also be light-absorbing.

An exemplary poster material according to the present invention includes a poster substrate made from a textile material at least one of (i) having a light absorbing coating encasing the textile material, and (ii) formed from yarn having a light absorbing coating. The poster material has on a first side a light reflecting coating and on a second side opposite the first side a light absorbing surface. The textile material has holes distributed one of regularly and in a regular pattern such that such that the poster material is see-through from the second side with the light absorbing surface.

The first side of the poster material may be flattened by thermic forming.

The light absorbing coating on the textile material may be made from a thermoplastic material and the light absorbing coating on the yarn may be made from a thermoplastic material.

An exemplary poster material according to the present invention includes a poster substrate made from a light absorbing textile material and formed from one of (i) thermoplastic yarns, and (ii) yarns having a thermoplastic coating. At least a first side of the poster material is flattened by thermic forming of the textile. The poster material has on the flattened first side a light reflecting coating and has on a second side opposite the first side a light absorbing surface. The poster material has holes distributed one of regularly and in a regular pattern such that the poster material is see-through from the second side with the light absorbing surface.

An exemplary poster material according to the present invention includes a poster substrate made from a light absorbing textile material. The poster material has on a first side a light reflecting coating and has on a second side opposite the first side a light absorbing surface. The poster material has holes distributed one of regularly and in a regular pattern such that the poster material is see-through from the second side with the light absorbing surface. The yarns forming the textile are one of fused together and encased in a coating at crossing points after crossing the yarns.

The light absorbing textile may be formed from thermoplastic yarns and/or yarns having a thermoplastic coating. The textile formed from the yarns may be coated after crossing of the yarns so as to encase the textile. Alternatively, the textile may be formed from previously coated yarns.

The first side of the poster material may be flattened by thermic forming, which causes the yarns to fuse at their crossing points.

Any of the above-described poster materials may also include a carrier material removably adhered to the poster substrate by means of an adhesive layer—such that the side of the poster material facing the carrier material is the second side with the light absorbing surface. The adhesive layer having a better adhesion towards the carrier material than towards the poster substrate such that after separation of the poster substrate and the carrier material the adhesive layer remains on the carrier material.

The second side of any of the above-described poster materials may also have at least one of a translucent separation/release layer, a transparent separation/release layer, and a protection layer. Further, the first side of the poster materials may also be provided with indicia.

The hole size of a given hole at or adjacent the first surface may be different than the hole size for the same hole at or adjacent the second surface.

The first side of the poster material may be provided with indicia.

The yarn used to form the textile may have an elongated cross section, e.g., an oval cross section, prior to thermic forming of the poster.

The yarn may have at least a first surface that is essentially flat.

The yarns may be fixed, e.g., by fusing, to one another at crossing points.

An exemplary method according to the present invention involves the production of a printable adhesion compound comprising at least a poster material with a poster substrate and a carrier material. The poster material has on a first side a printable surface and on a second side a light absorbing surface. The method comprises the steps of: (i) forming holes in the poster material, the holes being distributed one of regularly and in a regular pattern and configured such that in separated form the poster material is see-through from the second side with the light absorbing surface, the holes having a smaller diameter opening adjacent the first side than adjacent the second side; and (ii) removably adhering the poster material to the carrier material by means of an adhesive layer and such that the side of the poster material facing the carrier material is the second side with the light absorbing surface. The adhesive layer having a better adhesion towards the carrier material than towards the poster material such that after separation of the poster material and the carrier material the adhesive layer remains on the carrier material.

The method may also include the step of providing the first side of the poster material with one of (i) an image receptive light reflecting coating, and (ii) a light reflecting coating, and thereon an image receptive coating.

The method may also include the step of providing the first side of the poster material with a thermic formable coating. The holes in the poster material may be formed, e.g., by punching the poster material. The hole diameter adjacent the first side may be made smaller than the hole diameter adjacent the second side by thermic forming at least the first side of the poster material.

An exemplary method according to the present invention for the production of a poster comprises applying a light absorbing coating onto yarn, forming a textile material from the coated yarn, and applying on a first side of the textile material a light reflecting coating so as to form the poster material. The poster material having on a second side opposite the first side a light absorbing surface. The textile material may be woven such that it has holes distributed one of regularly and in a regular pattern rendering the poster material see-through from the second side with the light absorbing surface. The light absorbing coating may be made from a thermoplastic material.

The method may further include flattening the first side of the poster material by thermic forming.

The method may further include fixing, e.g., by fusing, the yarns to one another at crossing points.

Another exemplary method according to the present invention for the production of a poster comprises: (i) forming a poster material from one of thermoplastic yarns and yarns having a thermoplastic coating, the poster material having holes distributed one of regularly and in a regular pattern; (ii) flattening at least the first side of the poster material by thermic forming at least the first side of the poster material; (iii) applying a light reflecting coating to a first side of the poster material. The poster material has on a second side opposite the first side a light absorbing surface and is see-through from the second side with the light absorbing surface.

The method may further include flattening the second side. The first and second sides may be each flattened to a different degree.

Another exemplary method according to the present invention for production of a poster, comprises: forming a poster material from yarns, the poster material having holes distributed one of regularly and in a regular pattern; fusing the yarns forming the textile together at yarn crossing points; and providing a first side of the poster material with a light reflecting coating. The poster material has on a second side opposite the first side a light absorbing surface and is see-through from the second side with the light absorbing surface.

The method may further comprise flattening the first side of the poster material by thermic forming. The thermic forming also causing the yarns to fuse at the yarn crossing points.

The method may further include preventing the reflecting coating from flowing at least one of into and through the holes, e.g., by plugging the holes when applying one or more of the coatings to the poster and/or by using a sufficiently viscous coating.

The method may also include providing a light absorbing coating on the second side of the poster material.

Specific embodiments of the present invention will be further explained below by means of the figures. These figures merely represent exemplary embodiments and are not to be construed as in any way limiting the invention described in the appended claims.

### BRIEF DESCRIPTION OF THE DRAWINGS

FIG. 1 shows a scheme of the method for the production of a poster according to an exemplary embodiment of the present invention, wherein the poster material gets punched without an additional carrier/liner.

FIG. 2 shows a variant of the procedure of FIG. 1, wherein the poster material attached to a self-adhesive carrier material gets punched.

FIG. 3A is a cross section of a poster substrate according to an exemplary embodiment of the present invention.

FIG. 3B is the cross section of the poster substrate of FIG. 3A provided with a light absorbing layer.

FIG. 3C is the cross section of the poster substrate of FIG. 3B with an additional layer on the poster substrate.

FIG. 3D is the cross section of the poster substrate of FIG. 3C showing the poster material after perforation.

FIG. 3E is the cross section of the perforated poster substrate of FIG. 3D during its application onto a non-perforated carrier/liner material.

FIG. 3F is the cross section of the poster substrate of FIG. 3E in a completely laminated condition.

FIG. 4A is the cross section of the adhesion compound of FIG. 3F after application of an image receptive and/or thermoplastic layer and an image.

FIG. 4B is the cross section of the adhesion compound of FIG. 4A after thermic forming the image receiving side of the poster.

FIG. 4C is the cross section of the poster of FIG. 3D, wherein the holes in the poster have a tapered profile.

FIG. 4D is the cross section of the poster of FIG. 3D, wherein the holes in the poster have a square profile.

FIG. 4E is the cross section of the poster of FIG. 3D, wherein the holes in the poster have a curved profile.

FIG. 5 is the cross section of the adhesion compound of FIG. 3F, wherein the poster material is directly provided with an image.

FIG. 6 is the cross section of the finished poster substrate of FIG. 5 with the poster substrate partially peeled off the self-adhesive carrier.

FIG. 7 is the cross section of a poster substrate, including an image receptive layer, adjacent a window pane to which it is to be applied.

FIG. 8 is a cross section of the poster substrate of FIG. 6 but with a protective layer applied over the image.

FIG. 9 is a cross section of the poster substrate of FIG. 8 with a continuous protective film as the protective layer.

FIG. 10A is a cross section of an exemplary material according to the present invention having a carrier/liner material that is on both sides provided with an adhesive layer and thereon mounted poster material.

FIG. 10B is the cross section of the material shown in FIG. 10A with one of the posters partially peeled off.

FIG. 10C is the cross section of FIG. 10B after complete removal of the first and beginning removal of the second poster.

FIG. 11 is a cross section of a prior art sticking poster.

FIG. 12A is a cross section of an inventive adhesion compound according to an exemplary embodiment of the present invention with a one-sided, light absorbing poster material (not coated with adhesive).

FIG. 12B is the cross section of the material of FIG. 12A in a punched condition.

FIG. 12C is the cross section of the punched material of FIG. 12B with the adhesive coated material partially peeled off from the non-adhesive coated poster material.

FIG. 12D is the cross section of the punched material of FIG. 12C partially adhered to a non-perforated adhesive coated carrier.

FIG. 13A is a perspective view of a one-sided, black coated fibrous material adhered to an adhesive carrier/liner layer.

FIG. 13B is a cross section of the fibrous material and adhesive carrier/liner layer of FIG. 13A with the adhesive carrier/liner layer partially peeled off and showing yarn overlap at two adjacent locations.

FIG. 13C shows a simplified cross section of the fibrous material of FIG. 13B, with the fibrous material shown as a layer and provided with an image applied onto an adhesive carrier/liner that also caries an image.

FIG. 13D shows the cross section of FIG. 13C with the adhesive carrier/liner partially peeled off.

FIG. 14 is a perspective view of a fibrous, holey, woven textile according to an exemplary embodiment of the present invention.

FIG. 15 is a cross section through the yarns of the textile of FIG. 14 at a yarn crossing point.

FIG. 16 is the cross section of the textile of FIG. 15 after application of a thermal treatment.

FIG. 17A is a cross section at a yarn crossing of an exemplary textile material according to the present invention woven from a light absorbing, thermoplastic yarn.

FIG. 17B is the cross section of the material of FIG. 17A after it has been thermally fused and formed so as to provide at least a first flat surface.

FIG. 18A is a cross section at a yarn crossing of an exemplary textile material according to the present invention woven from a yarn having a light absorbing and thermoplastic coating.

FIG. 18B is the cross section of the textile material of FIG. 18A after it has been thermally fused and formed so as to provide at least a first flat surface.

FIG. 19A is a cross section at a yarn crossing of an exemplary textile material woven from a light absorbing yarn having a light absorbing thermoplastic coating on one side according to an exemplary embodiment of the present invention

FIG. 19B is the cross section of the textile material of FIG. 19A after it has been thermally fused and formed so as to provide at least a first flat surface.

FIG. 19C is the cross section of the yarn 16A of FIG. 19A, outside the yarn crossing, after it has been thermally treated according to an exemplary embodiment of the present invention.

FIG. 20A is a cross section at a yarn crossing of an exemplary textile material similar to the one shown in FIG. 19A but woven from a light absorbing yarn with flattened oval cross-section having a light absorbing thermoplastic coating on one side according to an exemplary embodiment of the present invention.

FIG. 20B is the cross section of the textile material of FIG. 20A after it has been thermally fused and formed so as to provide at least a first flat surface.

FIG. 20C is the cross section of the yarn 16A of FIG. 20A, outside the yarn crossing, after it has been thermally treated according to an exemplary embodiment of the present invention.

### DEFINITIONS

In order to ensure that the terms used herein are interpreted as intended, some definitions are provided below:

Thermic flattening or forming and thermo forming as used herein synonymously and describe a surface forming, wherein yarns or fabrics are heated to a predetermined temperature and a predetermined pressure is applied resulting in a flattening deformation or fusion of the yarns or in a flattening of at least one surface of the fabric. Heat and pressure may be applied simultaneously or separately one at a time. Heat and/or pressure may be applied to one side or to both sides of the fabric.

Light absorbing means that at least 60% of the impinging light gets absorbed.

Light reflecting means that at least 60% of the impinging light gets reflected.

Coating means a layer material that is applied to another material in liquid or solid form. Examples of coatings include adhesive coatings, primer coatings, release coatings, e.g., silicones, light absorbing coatings, such as black pigmented plastic coatings, light reflecting coatings, such as white pigmented plastic coatings, and metalizations. Exemplary methods for the application/attachment of coatings are printing, reverse roll coating, blade coating, etc. A coating is—in contrast to a substrate—not a bearing or integral constituent. In other words, it is neither responsible for the shape nor for the mechanical strength of the coated object, although it may add to the mechanical strength of the substrate, e.g., by helping to keep the yarns of a fabric in place.

Non-adhesive, non-adherent means that there is neither an adhesive coating nor electrostatic forces leading to an adhesion on specific surfaces.

The terms “holey”, perforated”, “provided with holes”, “punched”, and “die cut,” all describe materials wherein material-containing and material-free areas alternate in a regular pattern whereby some of the terms specify products that have been produced by a specific manufacturing step or a method. The term “holey” is used to designate a material that is translucent/see-through due to any kind of holes, i.e., it encompasses open work textiles (open work fabrics, mesh-like materials) as well as originally continuous materials that have been provided with holes e.g., by perforation, punching, die cutting, etc.

The terms open work material, open work fabric, open work textile, holey fabric, holey textile, mesh-like textile, mesh-like sheet are used herein interchangeably.

Hole means every material-free area or opening, respectively, in a material. Holes may be made directly during the production of, e.g., textures or interlaced yarns, or they can be made subsequently by hand or machine. They can have several shapes, e.g., round, multigonal or polygonal, regular or irregular, symmetric or asymmetric, and within one area different hole shapes, hole patterns and hole sizes can occur provided that the eye recognizes the structure or its sequence as regular.

Regular in relation to the arrangement of the holes means that the transparency is not affected due to irregularities.

Auxiliary layers may, e.g., be primer-coatings, adhesive coatings within the poster material or the carrier material, separating/release coatings that facilitate the separation of materials, and barrier coatings that prevent an undesired mixing of materials/diffusion. Auxiliary layers may be provided as additional layers wherever required or necessary.

Additional layers are, e.g., layers/coatings that improve the end product (the poster) yet have no impact on the adhesion compound and its usage during the manufacturing process of the poster. Such coatings in particular are protective layers that are used, e.g., above the information for its protection or for the generation of special effects. Such layers may, e.g., serve for the reduction of abrasion, for the increase of light resistance, for the increase of weather resistance and/or for the protection against graffiti.

The terms “side” and “surface” in relation to the poster material, the carrier material or the adhesion compound, respectively, are largely used synonymously.

The description of a surface as being light absorbing or light reflecting or appearing light absorbing or light reflecting includes also surfaces that comprise colorless or transparent, respectively, coatings/layers between the light absorbing or light reflecting coatings and the surface, or between the light absorbing or light reflecting substrates and the surface.

The term “adhesion compound” is used for all materials that at least comprise one poster material and one carrier material and that are separably joined together.

### DETAILED DESCRIPTION

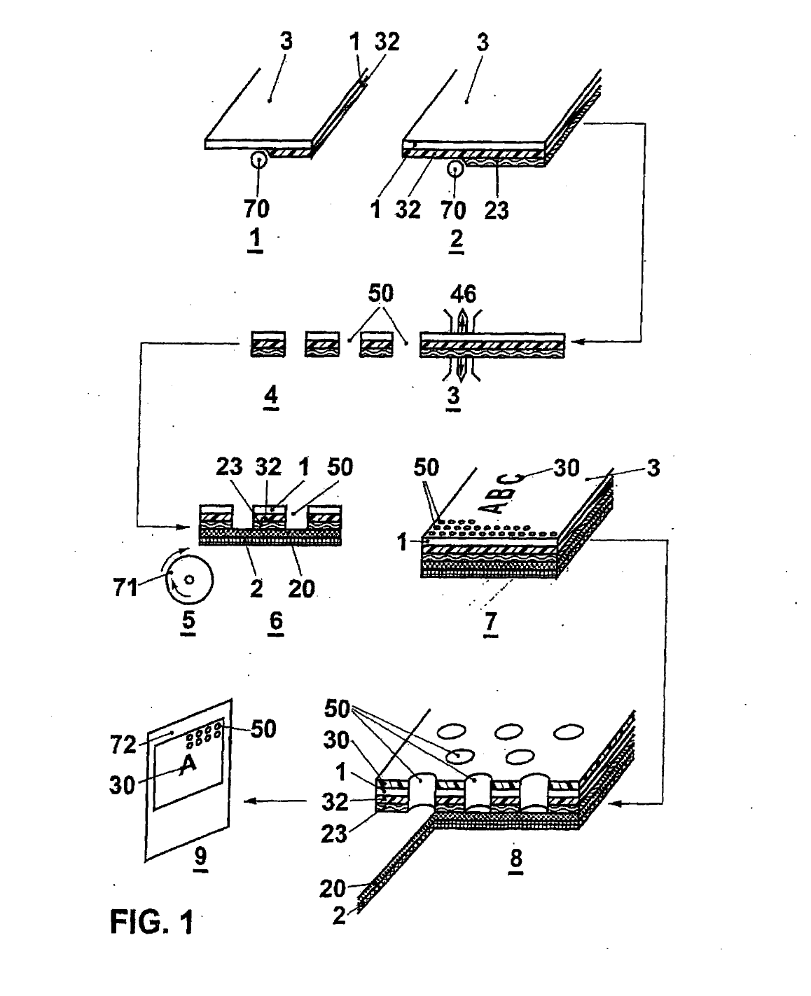

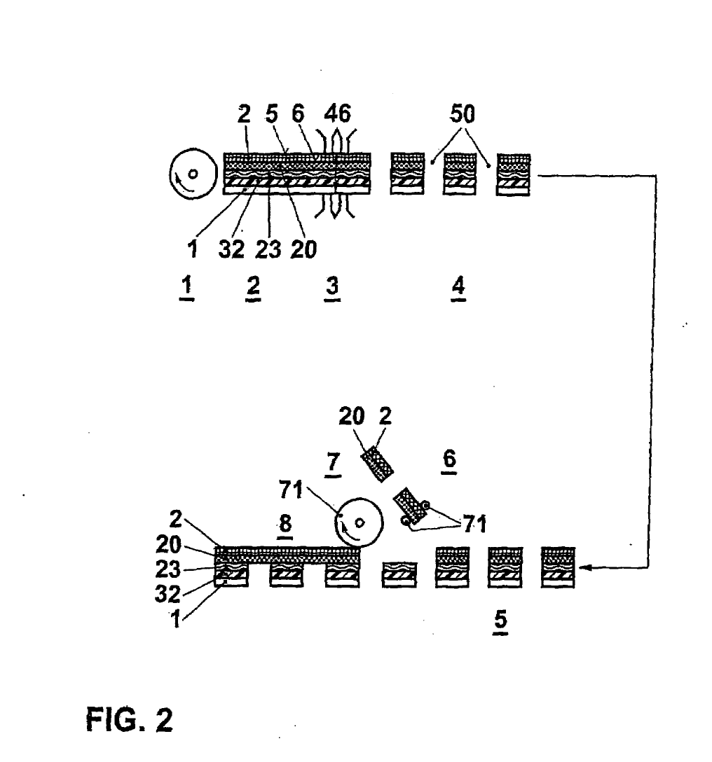

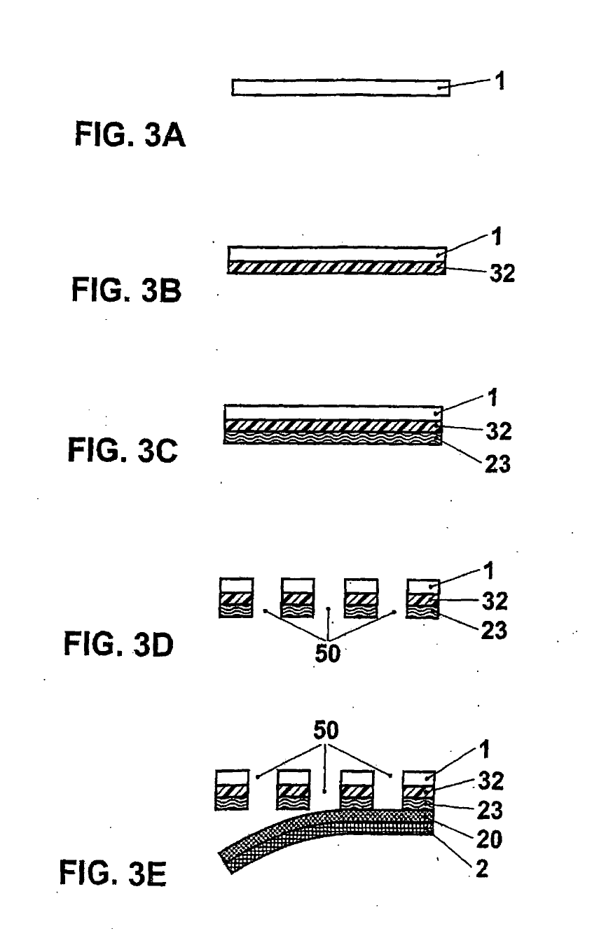

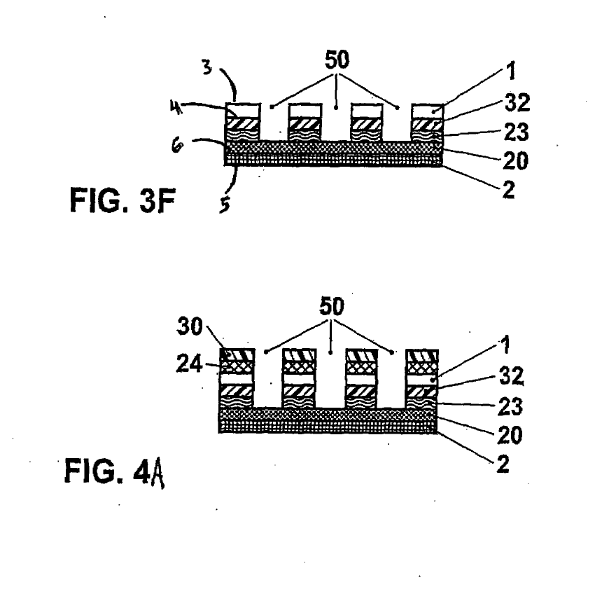

FIGS. 1 and 2, discussed in detail below, show the production steps of an adhesion compound according to an exemplary embodiment of the present invention. FIGS. 3A-3F show the step wise assembly of the poster layer-by-layer. Reference is first made to FIG. 3F, which shows a cross section of the adhesion compound, which is suitable for use, e.g., in the production of a non-adhesive, one-sided see-through poster.

The adhesion compound includes at least a poster material with a poster substrate 1 and a carrier material with a carrier substrate 2, wherein the poster material and the carrier material are separably joined together by an adhesive layer 20. The poster material has on a first side a printable or with an image receptive coating directly or after pre-treatment providable surface 3 and on a second side a light absorbing surface 4 facing the carrier material. The adhesive layer 20 has a better adhesion towards the carrier material than towards the poster material such that after separation of the poster material and the carrier material the adhesive layer 20 remains on the carrier material. The poster material has in at least an area regularly or in a regular pattern distributed holes 50, such that it is see-through (open-work, perforated) from the second side with the light absorbing surface 4. Such arrangement of material-comprising areas and material-free areas may occur, e.g., in a regular fibrous material or it can be created by means of perforation of a previously non-translucent/not-see-through, persistent material. The material thickness between proximate holes, or hole paths, respectively, varies by, e.g., at most 20%.

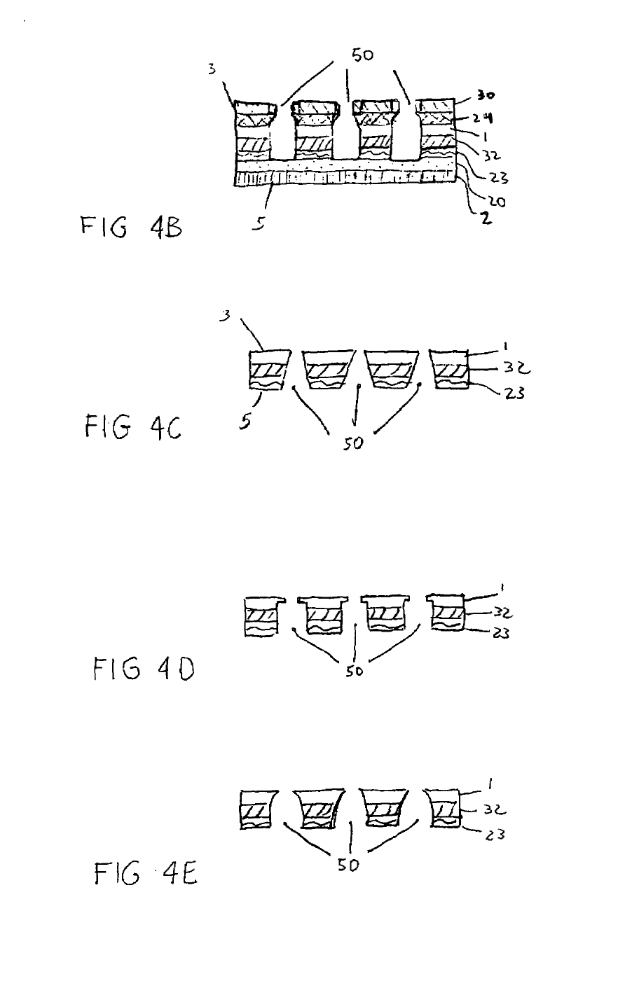

As shown in FIG. 4A, surface 3 can be provided with layer/coating 24, e.g., an image receptive and/or a thermic formable layer. The surface 3 that can be provided with layer/coating 24 can be directly furnished with layer/coating 24 or after a pre-treatment, e.g., a primer treatment and/or a corona treatment, etc., of the surface.

A poster material with printable surface 3 may for example be a printable material such as paper or a material on which layer/coating 24 has already been applied, e.g., a foil coated with an ink jet layer. Surface 3 is able to be provided with layer/coating 24 and may be any surface that allows to be coated or otherwise combined with or connected to a respective layer by means of fluid application, welding or laminating without harming the adhesion compound.

The adhesion of the poster material on the carrier material may be obtained through, e.g., extrusion, welding or by gluing, whereby for the gluing process an adhesive layer 20 is arranged between the poster material and the carrier material. The adhesive layer/coating 20 has a stronger adhesion towards the carrier material than towards the poster material.

The poster material may be a poster substrate 1 or it may comprise such substrate 1. The poster substrate 1 may be a uniform material or a material compound, such as a laminate, made from equal or different materials, e.g., differently colored foils.

The first surface 3 of the poster material may be light reflecting and may include, e.g., a light reflectingly provided foil that is part of the poster substrate 1, or a light reflective layer/coating or a light reflective print. Very light colors such as light yellow, light beige and especially white are generally considered as light reflecting. Light reflecting metalizations, such as aluminizations, may be used in order to obtain special effects.

Also the light absorbing surface 4 may especially be provided by a coating on the respective side of the poster material or by a suitably colored poster substrate 1 itself. Very dark colors, particularly black, are considered as suitably light absorbing. Any auxiliary layers that are applied on the light absorbing surface 4 such as layers which regulate the adhesion or increase the abrasion resistance and/or UV resistance are preferably chosen so as to not have an impact on the light absorption. Such auxiliary coatings/layers are considered as belonging to the poster material.

The carrier material may have a first side or surface 5 that may be printable and a second side or surface 6, facing the poster 1, that may be light absorbing. The first side 5 of the carrier material may also have a light reflecting surface.

The light absorbing or light reflecting surfaces 5, 6 of the carrier material may be generated according to the description above concerning the poster material. The carrier substrate 2 used for the carrier material may also be a material compound, particularly a laminate.

In such case, after perforation, the carrier material of the adhesion compound may be used as an adhesive, one sided transparent poster material. In addition to positive ecological effects, e.g., savings in material and energy, this leads to a bisection of the perforation costs and to savings at the materials costs, as perforated carriers do not have to be discarded and disposed.

If the adhesive layer 20 is missing in an adhesion compound that with respect to the other features is as described before, then the poster material as well as the carrier material (if non-adhesive) may be processed to a poster according to the present invention with the above mentioned advantages. Compound materials that are separable and after separation are non-tacky and do not adhere to any surface by their own are known to the skilled person.

As shown in FIG. 4B, thermic forming the surface 3 of the adhesion compound, e.g., by calendering, may cause the layer/coating 24 applied to surface 3 to flow towards a centerline of holes 50. This results in a hole size on or adjacent to the surface 3 that is smaller, e.g., 5% smaller, in effective diameter than the hole size on or adjacent to the opposite surface 5, which has a positive effect on the through-vision properties of the poster, perhaps because the reduced size hole on the surface 3 minimizes “pollution” inside the holes from image printing. In this case, the indicia 30 is applied after the thermic forming of surface 30. The positive effect on the through-vision properties is further improved if the poster substrate is light absorbing.

The degree to which a coating on the adhesion compound flows upon thermic forming will depend on the choice of coating material and the materials making up the adhesion compound. The poster material also may be chosen such that a thermic forming of the image receiving surface of the poster causes surface material to flow so as to reduce the hole size on the image receiving surface 3 even absent a coating on the surface 3.

The difference in hole size on surfaces 3 and 5 may also be accomplished without thermic forming. For example, as illustrated in FIG. 4C, the poster (shown without the carrier material) can be manufactured with holes 50 that vary in diameter. As shown in FIG. 4C, the holes taper from surface 5 to surface 3. However, other hole profiles may also be used that achieve a smaller hole on surface 3 than on surface 5, e.g., a square profile, as illustrated in FIG. 4D, a curved profile, as illustrated in FIG. 4E, etc. The holes may be formed, e.g., by scoring, drilling, using a laser, etc.

Thermoplastic materials are well known to the skilled person and encompass, e.g., polyolefins such as polyethylene (PE), polypropylene (PP), polybutadiene (PBD), polyesters such as polyacrylates, polyethylene terephthaletw (PET), polybutylene terephthalate (PET), polyether ether ketone (PEEK), polyamides, polyacrylonitrile, ethylene-vinyl acetate (EVA), ethylene vinyl alcohol (EVAL), polyethersulfones (PES) and many more. The thermoplastic material of choice is selected in view of glass point and, if black and/or forming the first surface 3, for its suitability to be, e.g., filled with black pigment and/or its printability or ability to be coated with a printable layer, optionally after application of a primer layer.

Exemplary poster materials are flame retardant, in the case of coated material both the yarn and any coating may be flame retardant. Flame retardant materials are known to the skilled person as well as the flame retardant materials that may be used in specific plastic materials.

Often used flame retardants are, e.g., halocarbons, such as polybrominated diphenyl ether, polybrominated and polychlorinated biphenyls, chlorinated paraffins, and chlorendic acid derivatives, such as dibutyl chlorendate and dimethyl chlorendate. Another group includes phosphorous comprising compounds, e.g., phosphonium salts such as tetrakis(hydroxylmethyl) phosphonium salts, and tri-o-cresyl phosphate, tris(2,3-dibromopropyl) phosphate, bis(2,3-dibromopropyl) phosphate, tris(1-aziridinyl)-phosphine oxide. Another flame retardant material is aluminium hydroxide.

One possibility to provide the adhesion compound with holes 50, i.e., to make it holey, is by a perforation that during the production is performed through the whole adhesion compound and—in direction perpendicular to the direction of the perforation—in at least specific areas, and which may be over the whole adhesion compound. In a further production step, such an adhesion compound may be disconnected and the perforated material may be applied on a new, continuous, i.e., not holey, carrier material for simple printing and/or for protecting the light absorbing surface against pollution.

At a later stage of the production method, the first, light reflecting surface 3 of the poster material may be provided with indicia 30, such as an image and/or text.

A very regular allocation of the material-free areas 50, the holes, is necessary to obtain on the one hand a good through sight and on the other hand a good visibility of the information, e.g., a clear picture. A very good combination of the two competing demands is obtained when the regularly allocated material-containing and material-free areas of the poster material, and optionally the carrier material, are such that the material-free areas have a diameter of 1 to 5 mm, in particular 1 to 2 mm, and the material-containing areas provide 30 to 60%, in particular 30 to 50%, of the poster area, wherein the sum of the material-free and the material-containing areas is 100%.

The material-free areas 50, the holes, may be round, and may also be identical. Such holes 50 may be perforation holes or punching holes or formed by drilling, or using a laser, or by weaving, etc.

In an exemplary embodiment of the present invention, the sum of all areas with holes 50, e.g., the perforated area or area between yarns, etc., is at least 50% of the total area of the adhesion compound or the poster material or poster, respectively. The entire poster material/poster may also be see-through due to holes 50, possibly except a small area (“frame”) adjacent the edges.

In a further embodiment of the inventive adhesion compound, the light absorbingly and/or the light reflectingly colored material, or the material that is provided with a light absorbing and/or a light reflecting coating or layer may be provided with a transparent auxiliary layer, in particular with a separating/release layer 23 improving the separation of the carrier material or with a coating improving the printability.

Also a subject of the present invention is a non-adhesive/non-adherent poster material as described above that is provided with regularly allocated (distributed) holes 50 and that on the first side has a printable surface 3 or a surface 3 that may be provided with a printable layer/coating and that on the second side has a light absorbing surface 4, and wherein the poster material has neither on the first side 3 nor on the second side 4 an adhesive layer 20, in particular a poster material that on the first side 3 is light reflecting.

On the light reflecting first side 3, the poster material may carry information and is then generally referred to as a poster.

While with special printing machines directly printing on a holey poster material may be done, e.g., by sucking excessive color off the light absorbing side or by feeding the poster material to the printing facility simultaneously with and pressed on a protection material (e.g., a sucking paper or a soft plastic foil that due to its softness “seals” the holes), printing in an adhesion compound and subsequent disconnection may be better. Such a method is further described below taking into consideration different alternatives.

The adhesion compound is perforated, e.g., by dye cutting, punching, drilling, using a laser, etc., and then disconnected. The carrier material will then either be discarded or be further processed as a poster material of the state of the art in a respective adhesion compound.

The inventive poster material obtained as described above may be applied to a continuous (not-holey) carrier with its second, light absorbing side 4. The continuous carrier possesses an adhesive layer 20 that may be totally residue free releasable from the poster material, i.e., the adhesive layer 20 totally remains on the carrier material. The adhesion compound then is subjected to coating steps/printing steps wherein —depending on the requirements—not yet existent layers such as, e.g., adhesion improving (primer) layers and/or a light reflecting printing or coating and/or an image receptive layer and/or a print of information and/or a protective layer, are applied.

Alternatively, the poster material may be perforated alone, i.e., without a carrier material, or produced by weaving, and then used as a poster material or applied directly on a continuous, not perforated carrier for further processing.

Provision may be made for a “both sides” adhesive coated carrier with poster material on both sides and to further process such a compound accordingly, e.g., in that successively first the one and then the other side are printed, or by simultaneously printing both sides in appropriately equipped facilities. Such “sandwich” type adhesion compound with continuous poster material can also be used in the perforation step.

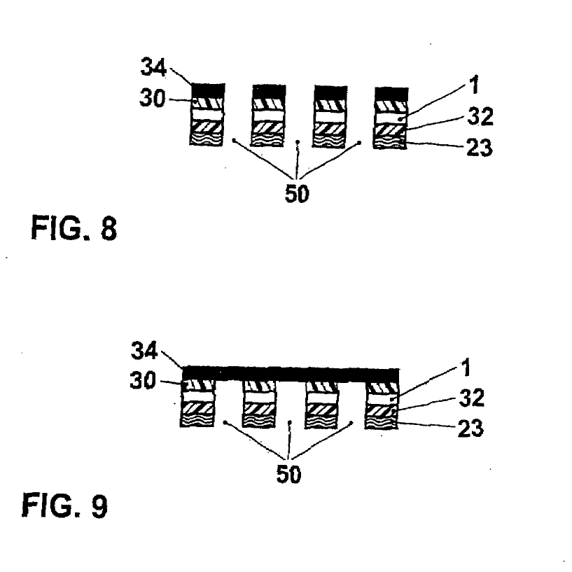

After application of the information/indicia 30 and optionally a protective layer/coating 34, as shown in FIG. 8, the poster may be separated from the carrier. Any carrier material that may accumulate during production can relatively easily be collected and re-used or recycled.

The poster 1 may then be leaned against a window or—if the material has sufficient stability—it may, e.g., be hung up or erected in a shop-window. In case that the material itself is not sufficiently dimensionally stable, it may be stabilized by means of a frame, such as a clip-on picture frame, which preferably minimally impacts visibility and transparency.

Returning now to FIG. 1, which shows in nine steps a method for the production of a poster 1 starting from a poster material that is perforated without a carrier.

Step 1 shows the application by means of a roller 70 of a light absorbing, such as a black, coating 32 on a poster substrate 1. The application of such a coating 32 may be achieved through, e.g., coating with fluid material or by laminating with an appropriate foil. The first side or surface 3 of the poster substrate 1 is suitable for the application of indicia 30, such as text, an image, and/or other information, by means of printing methods. The result of this first step is a poster material as described above.

Step 2 shows the poster material made in step 1 at the application of an auxiliary layer, in this case a separating/release layer 23, on the light absorbing layer 32. The separating layer is chosen such that the respectively coated surface 4 of the poster material is still light absorbing. The separating/release layer 23 thus may also be a light absorbing layer or a colorless, transparent layer. This coating can also be applied as a fluid (liquid) or as a foil whereby the application of the layer as a fluid (liquid) may be used.

Step 3 shows the perforation step whereby a perforating tool 46 is shown during the break-through of the poster material 1, 32, 23. The arrows indicate the direction of the perforation and the movement of the tool 46.

Step 4 is a cross section representation of the poster material provided with holes 50 after the punching step.

Step 5 shows a roller 71 with which an adhesive 20 and a carrier substrate 2 (the carrier substrate 2 here is identical with the carrier material), or an adhesive 20 coated carrier material, are applied to the poster material.

Step 6 shows the resulting adhesion compound. The application of indicia 30 by means of printing methods takes place between the steps 6 and 7, and the perforated and printed adhesion compound is shown in step 7.

Step 8 shows the disconnection of the adhesion compound and step 9 shows the final product, applied to a window pane 72.

FIG. 2 shows different steps of the inventive method starting from an adhesion compound, shown in cross section, that prior to perforation has been provided with a carrier material.

Step 1 schematically illustrates a roll of adhesion compound having the construction described in step 2 in cross section. This base adhesion compound consists of (from top to bottom) a carrier substrate/carrier material 2, an adhesive layer 20, and a poster material made of a separating layer 23, a black layer 32, and a poster substrate. 1. The carrier material may have a printable surface 5 that is turned away from the adhesion coating 20 and a light absorbing surface 6 that is turned towards the adhesive layer 20.

In step 3 the die-cutting of the adhesion compound by means of the tool 46 is shown and in the steps 4 and 5 the completely perforated adhesion compound is illustrated.

Steps 6 and 7 show the disconnection of the perforated adhesion compound and the application of the perforated poster material on a new, not perforated carrier material by means of adhesive layer 20 and with application of a transport roller 71, whereby a new adhesion compound is generated.

FIG. 3A is a cross section through a poster substrate 1 that has been provided with a light absorbing coating 32 in FIG. 3B.

FIG. 3C shows the material of FIG. 3B with an additional separating/release layer 23, e.g., a silicone layer. Such layer may be useful if the adhesion of the adhesive on the carrier material is not sufficiently stronger than on the poster material or if an undesired (e.g., irregular) cohesive fracture would occur.

FIG. 3D shows the material of FIG. 3C after application of holes.

FIG. 3E shows how the poster material of FIG. 3C is stuck together with an adhesive layer 20 coated carrier such forming an adhesion compound wherein the separating/release layer 23 separably adheres to the adhesive layer 20. The adhesion between the separating layer 23 and the adhesive layer 20 may be adjusted such that the adhesion is just sufficient to survive the intended further steps of the method without any problems, in particular the printing of an indicia 30 and —if necessary—previously the application of an image receptive layer.

FIG. 3F finally shows the material produced according to FIG. 3E.

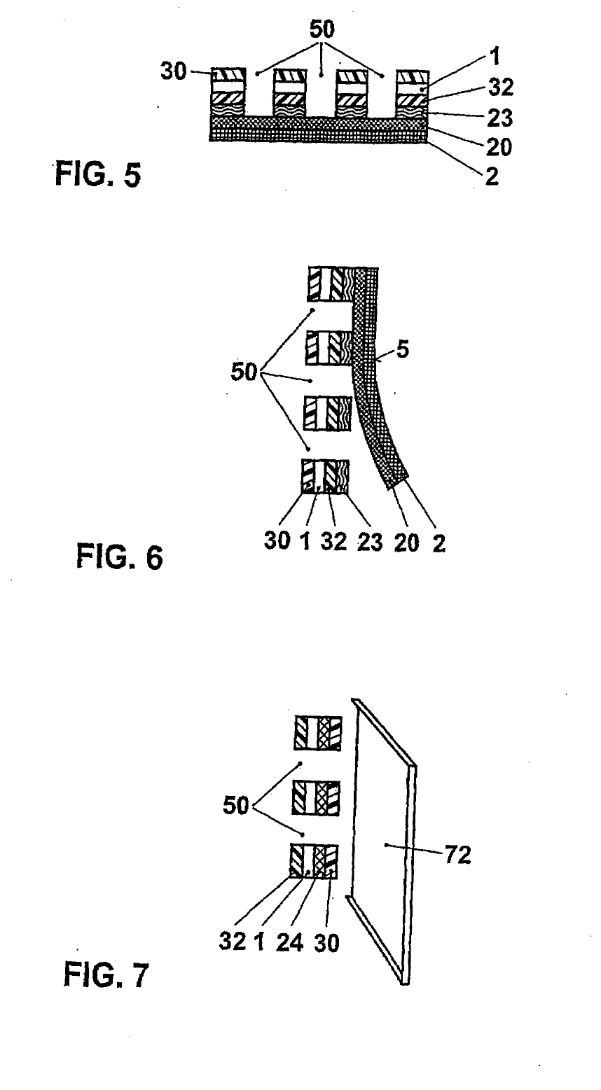

FIG. 5 shows the material of FIG. 3F, wherein the surface 3 of the poster substrate 1 is directly suitable for the printing of information, after the application of indicia 30.

FIG. 6 is a cross section through the material of FIG. 5 during separation of the finished poster from a self adhesive carrier 2,20. Provided that the self adhesive carrier 2,20 is not too badly soiled, it can be re-used again as a carrier. Alternatively, and not shown in the Figure, such a carrier can (provided that it is printably featured on the not adhesive coated side or surface 5), be provided with indicia either at a stage where it is still in the above described adhesion compound, or at a later stage joined to a liner. Such a printed carrier can be used as a common transfer image.

FIG. 7 schematically shows the step of attaching a poster (shown in cross section) onto a glass pane 72. The poster consists of a poster material comprising a light absorbing layer 32, a poster substrate 1 as well as an information layer 30, and an image receptive and/or thermic formable layer/coating 24.

FIG. 8 is a cross section through a poster analogous to the peeled off poster in FIG. 6 with an additional layer applied over picture 30, a protection layer 34. Here, the protection layer was applied in liquid form wherefore the holes 50 have also been formed. In this embodiment, the protection layer 34 may optionally contain a special effects generating filler that only mildly decreases transparency and need not be fully transparent and colorless.

FIG. 9 is a cross section through a poster similar to the poster illustrated in FIG. 8 but wherein the protection layer 34 is applied as a continuous protection film, in particular a transparent, at least mostly colorless lamination foil.

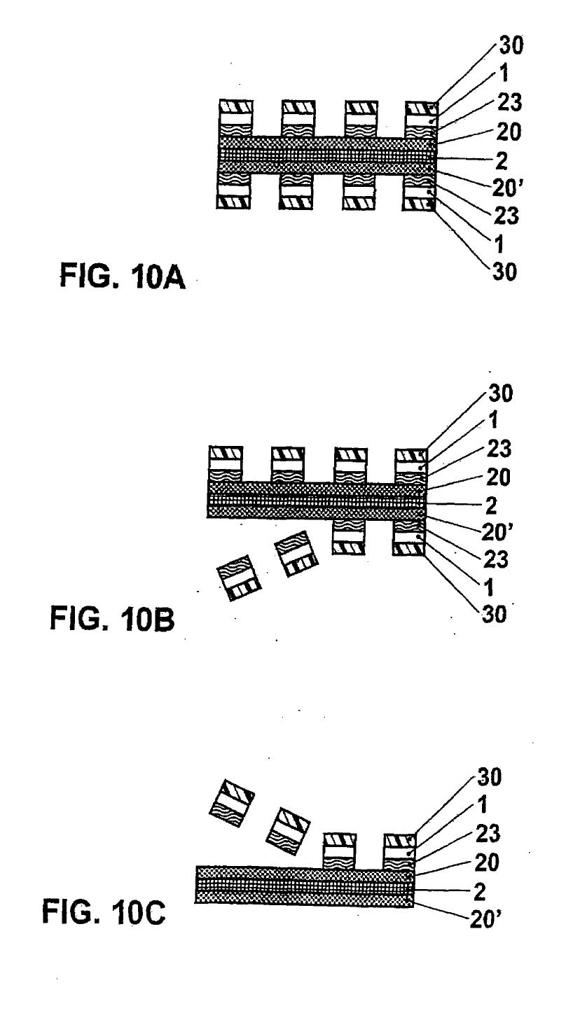

FIG. 10A is a cross section of a materials savings variant of an exemplary adhesion compound of the present invention as it might be delivered to the end user. In this embodiment, by using a carrier material that is on both sides coated with adhesive 20, 20′, two posters can simultaneously be provided. The posters can be formed either by (i) a separating/release layer 23, a light absorbing poster substrate 1, and an information printing 30 on a white base coat, or by (ii) a poster substrate 1 being a laminate made of a light absorbing foil and a light reflecting foil, wherein the indicia 30 has been directly applied on the surface 3 of the light reflecting foil. This may be reasonable if the indicia 30 on the two posters is interrelated such that it has to be ensured that always the desired set is delivered to the end user, or if a carrier is desired to enhance the stability during transport. A respective sandwich that has not yet been provided with indicia 30 is also advantageous for the use in printing equipment suitable for more or less simultaneous front and back side printing, and thus for shipping from the adhesion compound manufacturing site to the printing facilities.

FIG. 10B shows the material of FIG. 10A during detachment of one of the posters and FIG. 10C shows the material of FIG. 10B after complete separation of the first poster and started detachment of the second poster. If the posters neither have interrelated information nor need stabilization during transport, they can be removed from the carrier at the production site thereby improving the collecting and recycling of the carrier material.

If the two inventive poster materials are to be perforated simultaneously, i.e., in one perforation step, an adhesion compound formed from a double sided sticking carrier material and two poster materials can also be used in the perforation step.

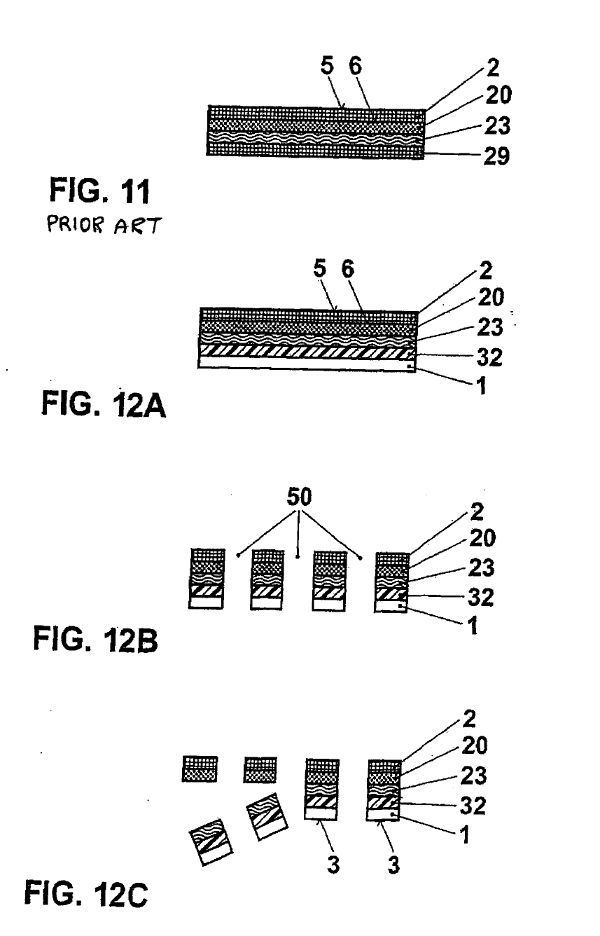

FIG. 11 is a cross section of a prior art adhesion compound including an adhesively bonded, one-sided see-through poster with a substrate 2 having a light reflecting, printable surface 5, and a light absorbing surface 6, and which comprises a usual removable carrier 29 instead of the poster material according to the present invention.

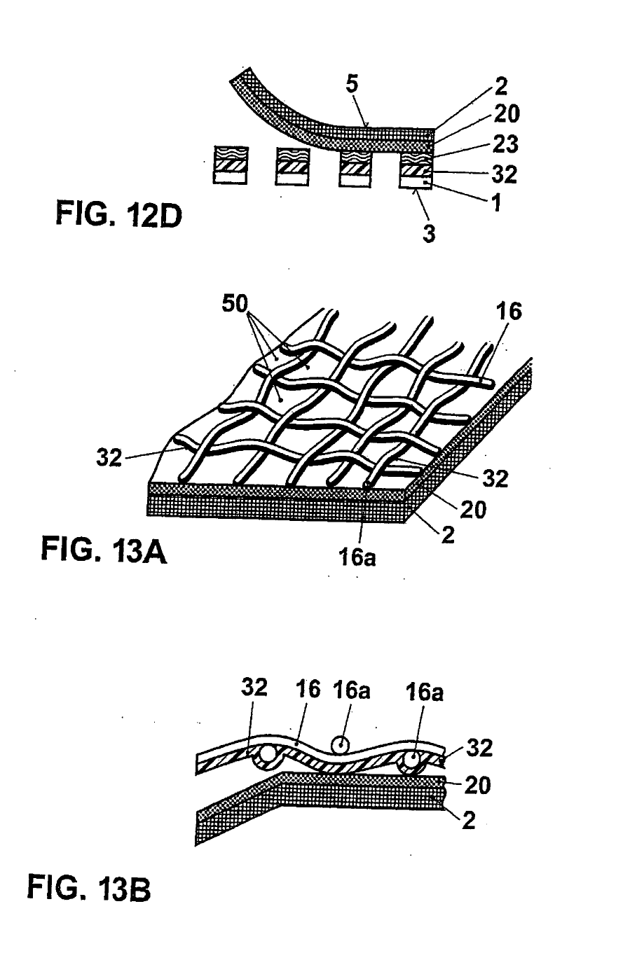

FIGS. 12A-12D show for a sticky material, like the one shown in FIG. 11, an exemplary improvement achievable by the present invention. By not anymore using a common liner for covering the adhesive layer 20, but a poster material according to the present invention with a light absorbing layer 32 on the side 4 of the poster substrate 1 being oriented towards the adhesive layer (FIG. 12A), the complex perforation procedure can be carried out simultaneously for two poster materials, for a poster material comprising a layer of adhesive material (in the scope of the present invention, such adhesive poster material is in general referred to as carrier material), which will be processed further to a sticky poster as known from the state of the art, and for an inventive poster material that is free of an adhesive layer (FIG. 12B).

FIG. 12C shows the separation of a poster material provided with an adhesive layer 20 from a poster material free of an adhesive layer. Alternatively, the procedure of FIG. 12A to FIG. 12C might also be applied for simultaneously manufacturing two inventive, punched non-adherent poster materials, namely when, e.g., a separable compound material free of any adhesive layer is used. Such materials include co-extrusion products and welded products.

In a further process step of the present invention, an adhesive coated, non-perforated carrier may be applied onto the adhesive-free poster material (FIG. 12D). This step may be desirable when the printing apparatus construction does not provide any means by which a pollution of the light absorbing side during the printing procedure can at least be reduced and may be completely avoided. Such means are, e.g., a sucking (exhaust) device, or the simultaneous supply of a covering foil that can be pressed onto the poster material, or a roll provided with an adequate surface, all of which are applied to the poster opposite the printing surface. If the material is adequately chosen, not only the surface 3 of the poster material can subsequently be printed with indicia 30, but also the surface 5 of the carrier material with indicia 21.

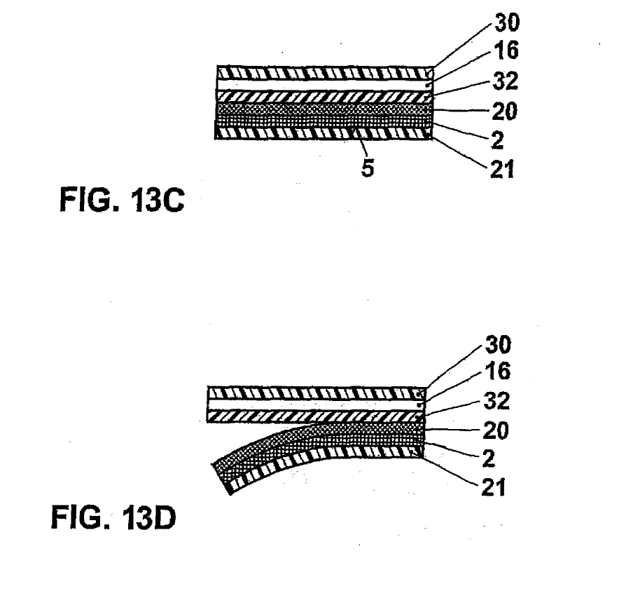

FIGS. 13A-13D show a poster material according to an exemplary embodiment of the present invention, which does not need to be perforated, since it is a loose, light permeable fibrous material, e.g., a fabric, formed from yarns 16, 16A, e.g., by weaving, and thus is already “holes” comprising. As can be seen in FIG. 13A, this fibrous material is coated on one side with a light absorbing coating 32. The coating 32 may be chosen and applied so as to not affect the regular, light permeable structure of the fibrous material. This one sided light absorbingly coated fibrous material may then be bonded with its light absorbing side onto a self adhesive, separable foil 2, 20 (FIG. 13B) to facilitate processing in various printing apparatuses. This foil, the carrier, may be sufficiently elastic and soft so that it nestles to the light absorbing side 4 of the fibrous material so as to prevent spoiling of the light absorbing side during the printing procedure.

FIG. 13C shows an exemplary embodiment of an adhesion compound according to the present invention, wherein not only the fibrous material comprises indicia 30 but also the carrier material 2, 20, 5 is provided with indicia 21. As already described above, after having been printed with indicia 30, the carrier material 2, 20, 5 can be peeled off the inventive poster (FIG. 13D) and its adhesive layer can be covered with a foil comprising a separation/release layer.

In a further exemplary embodiment of the present invention, and analogous to the above description, an “open work” poster material (not shown) can also be manufactured with a light reflecting side 3 provided with a metallization, which does not need to be printable. Such a material, for example, is adequate to be used as a reflective covering of glass panes, e.g., of winter gardens.

As already indicated, the poster material and/or the carrier material may be or may contain light absorbingly colored paper or paper coated with a light absorbing coating, or the poster material and/or the carrier material may be or may contain a light absorbingly colored plastic foil or a plastic foil coated with a light absorbing coating. Also suitable are materials that contain paper and/or plastic foil, e.g., multi-layered composites made from paper and/or plastics, from different plastics or from paper and/or plastics and another material, such as a metal or fibrous material. Suitable poster materials are also fibrous materials, in particular holey fabrics made from textile fibers and/or plastic fibers. The open work fabric may be made of textile fibers and/or synthetic fibers.

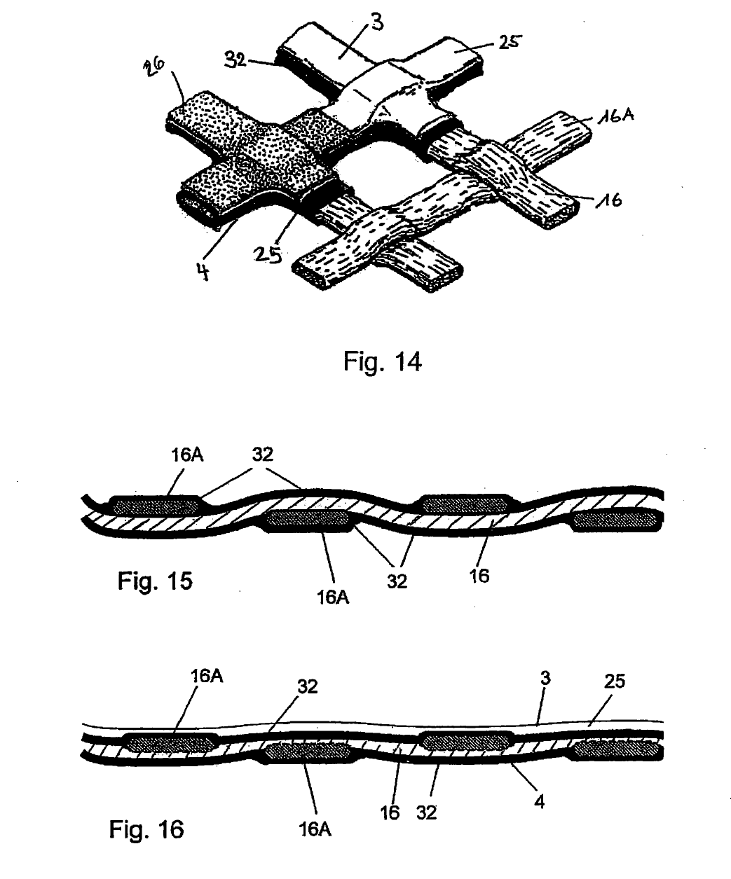

FIG. 14 illustrates such an “open work” material made from a black textile obtained by applying a: light-absorbing coating 32 on already woven yarns 16, 16A (partially exposed for clarity) so as to completely surround/encase the yarns 16, 16A. Alternatively, the yarns may be coated prior to formation of the fabric. The open work material of this embodiment has at least one surface, which is the first surface 3 to be printed, and a second surface 4, which is light absorbing and directed to the adhesive layer on the carrier material (not shown in FIG. 14). The first surface 3 may be directly printable and directly printed and/or may be first coated with a light reflecting layer 25, e.g., of sufficient viscosity to minimize pollution of the second, light absorbing surface 4. For clarity, light reflecting layer 25 is shown over only a portion of the fabric.

The light reflecting coating 25 on the first side 3 may also be image receptive. However, in case that it were not, a transparent or light reflecting image receptive coating 26 may be applied on the light reflecting coating. For clarity, image receptive coating 26 is also shown over only a portion of the fabric. Optionally, the image receptive layer/coating 26 is applied on the light reflecting coating 25 after pretreatment. Such image receptive coating 26 then may be provided with indicia, e.g., an image and/or a text.

Holey fabrics according to the present invention may be produced by several methods. Several exemplary methods are described below:

(i) A flat, fibrous, unifilar or multifilar yarn, e.g., made from nylon, and/or fibrous material is woven and the woven mesh-like textile/sheet material is then light absorbingly coated so as to encase the woven yarns, resulting in a light absorbing stabilized mesh-like material or textile. Optionally, in order to improve the stability and/or the flatness of at least the first surface of the resulting poster material, thermic forming, e.g., using a calender, may be applied to the woven material. Acceptable stability may result without thermic treatment, e.g., if the applied coating is sufficiently thick to minimize relative movement of the yarns and/or the yarn used is sufficiently flat. Such embodiment thus can also be readily used with materials that are not easily thermically formable.

(ii) A unifilar or multifilar thermoplastic yarn is woven into a mesh-like sheet material. This material is then thermally fused and formed, e.g., in a calender, to provide for at least a first flat surface of the resulting woven material. The yarn used to form the mesh-like material may be light absorbing.

(iii) A unifilar or multifilar yarn having a light absorbing and thermoplastic coating is woven to give a mesh-like sheet material. This material may then be thermally formed, e.g., in a calender, to provide for at least a first flat surface of the resulting woven material. The thermal forming may also fuse the yarns at their crossing points.

(iv) A light absorbing unifilar or multifilar yarn, e.g., a polyester yarn, is woven into a mesh-like sheet material. The yarn has a light absorbing thermoplastic coating that is sufficiently thick such that a thermo treatment after weaving results in a thermic fusion of overlapping yarns and in a flattening of a first surface of the woven material. Such treatment may be performed, e.g., in a calender resulting in a yarn with a cross-section approaching the form of, e.g., a 90° turned D or a half circle.

The light absorbing or light absorbingly coated textile formed via the above described methods may then on the first, flat side be provided with indicia, such as text or an image. Alternatively, prior to providing the indicia, the first flat side may first be provided with a light reflecting coating using a coating material, e.g., whose viscosity is chosen so as to minimize coating material flow into the holes. The thickness of such light reflecting coating, in case of 30 to 50% open area, may be, e.g., 10 to 12 g/m². Exemplary coating methods suitable for applying the light reflecting coating include, e.g., cascade coating, rotogravior printing, flexo graphics printing, etc.

The poster substrates manufactured according to any one of the above described methods demonstrates improved see-through properties. The walls defining the holes are black, which has proven to add to the regular impression of the observer.

Further, the stabilization of the woven material due to coating and/or thermic fusion, i.e., the reduction of relative yarn movement due to fixation of the yarns at crossing points, adds to the conservation of the regularity of the hole pattern and, therewith, also improves the see-through properties of the poster.

Also, the use of flat yarns with a much elongated oval cross section, due to the slightly rounded edges assists in avoiding “pollution” of the walls defining the holes during application of a light-reflecting coating or indicia. In the case of thermic forming of primarily one side of the open work material (shown in FIGS. 4B-4E for the sheet material embodiment), the diameter of the holes at the first surface may be slightly reduced, i.e., the holes narrowed at the first surface 3, which also leads to a protection of the walls of the holes.

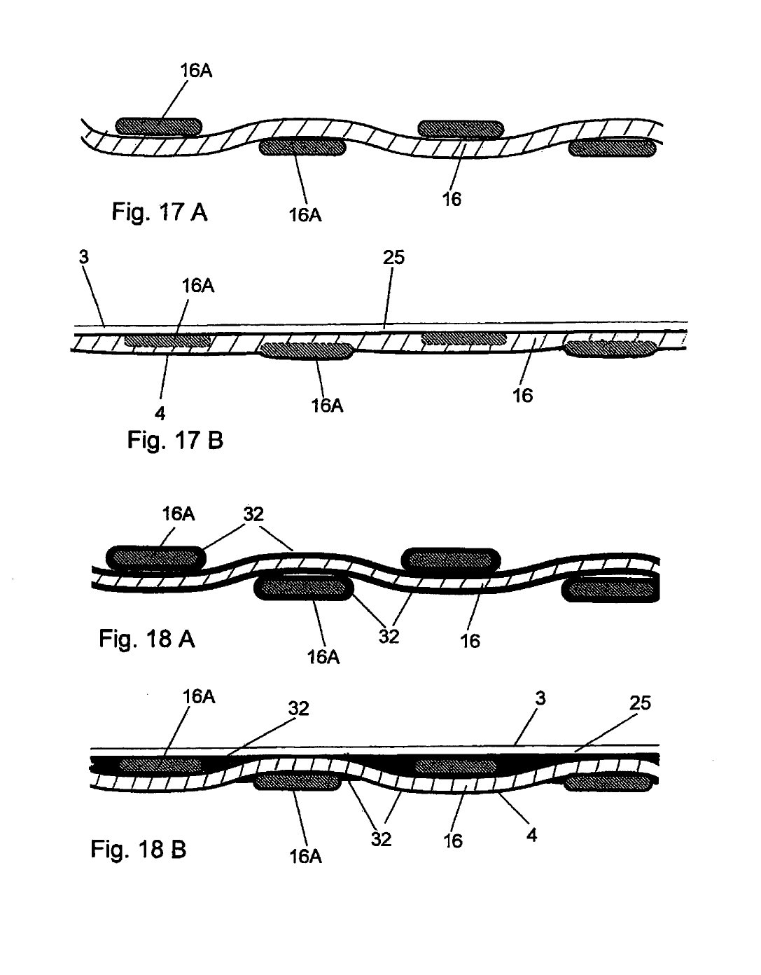

FIG. 15 is a cross section of the textile of FIG. 14 (through a yarn crossing point) shown without a light reflecting coating 25 and before any thermal forming. FIG. 17A is also a cross section of the textile of FIG. 14, shown without a light reflecting coating 25 and before any thermal forming, except that textile is woven from a thermoplastic yarn 16, 16A that is itself light absorbing and the textile is not coated with a light absorbing material.

The first surface 3 can be further improved for the application of a light reflecting coating and/or an indicia print if the textile is flattened by thermally forming. FIG. 16 is a cross section of the textile of FIG. 14 after thermal forming (and optionally fusing of yarns at their crossing points) and including a light reflecting coating 25 over the flattened first surface 3. FIG. 17B is a cross section of the textile of FIG. 14, after thermal forming and fusing and including a light reflecting coating 25 over the flattened first surface 3, but wherein the textile is woven from a thermoplastic yarn 16, 16A that is itself light absorbing.

FIG. 18B is cross-section through a textile according to an exemplary embodiment of the poster material of the present invention. In this embodiment, the surface of the second side 4 of the poster material is the second side of a textile material woven from a yarn 16, 16A having a light absorbing, e.g., thermoplastic, coating 32, which is then thermally fused and formed to result in at least a first flat surface 3, which is coated with a light reflecting coating 25. Although not illustrated as such, the yarn 16, 16A may also be light absorbing itself independent of the coating and may also be multifilar. FIG. 18A is a cross section of the same textile as that of FIG. 18B prior to thermal fusing and coating with the light reflecting coating 25.

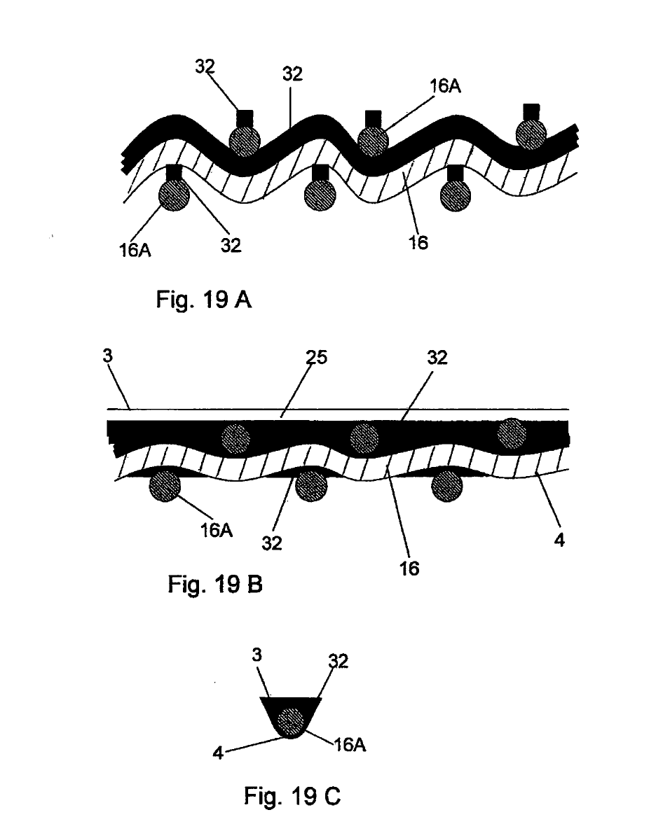

In another exemplary embodiment of the poster material, a cross section of which is shown in FIG. 19B, the surface of the second side 4 of the poster material is the second side of a textile material woven from a light absorbing yarn 16, 16A, with a light absorbing thermoplastic coating 32 on one side. The coating 32 is sufficiently thick that a thermo treatment after weaving, e.g., in a calender, results in a thermic fusion and in the formation of a flat first surface of the yarns between the fused areas in the shape of a 90° turned D, or as shown in FIG. 19C, in the shape of a half circle. FIG. 19A is a cross section of the poster material prior to the thermo treatment.

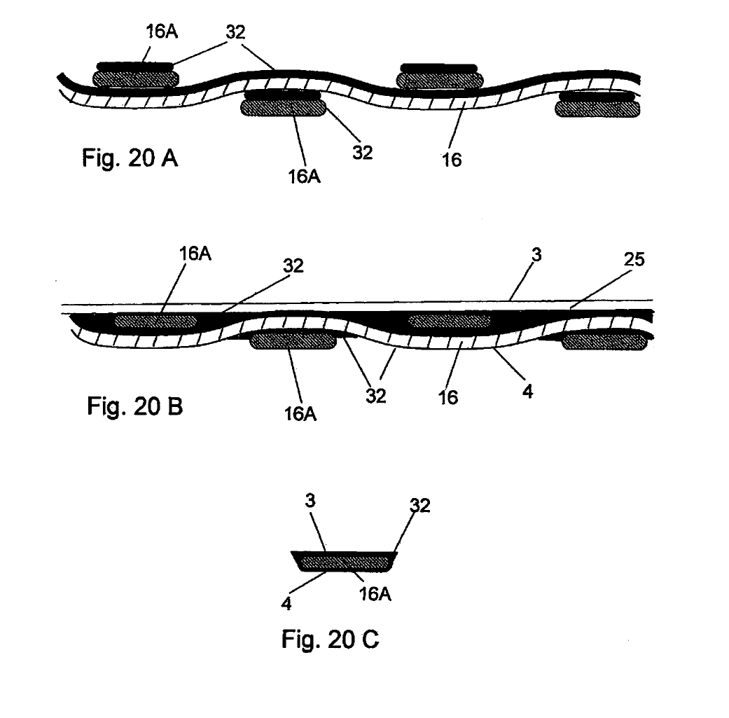

The yarns used may have different cross sections such as, e.g., a flattened oval cross section, as shown in FIGS. 14 to 18, or a round cross section, as shown in FIGS. 19A to 19C. Use of yarns with an elongated oval cross section, as shown in FIGS. 20A to 20C, facilitates flattening and reduces coating “pollution.”

FIG. 20A is a cross section at a yarn crossing of an exemplary textile material similar to the one shown in FIG. 19A but woven from a light absorbing yarn with flattened oval cross-section having a light absorbing thermoplastic coating on one side.

FIG. 20B is the cross section of the textile material of FIG. 20A after it has been thermally fused and formed so as to provide at least a first flat surface.

FIG. 20C is the cross section of the yarn 16A of FIG. 20A, outside the yarn crossing, after it has been thermally treated according to an exemplary embodiment of the present invention.

Although not shown in FIGS. 14 to 20C, for the application of a light reflective printing and/or indicia printing, the therein illustrated holey textile may be adhered to an adhesive carrier, which may, e.g., be a foil or paper. In one exemplary embodiment, the carrier is a foil that is sufficiently elastic and soft so that it nestles to the light absorbing side 4 of the fibrous material so as to minimize spoiling of the light absorbing side 4 during the printing procedure.

Although in some of the FIGS. 14 to 20B the textile material after thermic treatment is represented as being formed on both sides it should be understood that the present invention encompasses embodiments with (i) only one flattened surface, e.g., the first side, (ii) with opposing sides flattened to different degrees, e.g., the first side more extensively flattened than the second side, and also (iii) both sides equally flattened.

While flattening the first surface results in a overhang of the material of the first side into the hole therewith providing protection from pollution of the walls of the holes (as illustrated for the thermically formed adhesion compound, illustrated in FIGS. 4A and 4B), flattening the second surface improves the adherence of the liner and, thus, the protection of the second surface from pollution by light reflecting material passing the holes. Variables which may affect the choice of which side to flatten and to what relative degree include, e.g., the viscosity of the light reflecting and/or light absorbing materials used, the form and thickness of the yarns, the flexibility of the liner, the choice of adhesive, the thickness of the fabric, etc. In an exemplary embodiment, the first surface is more flattened than the second side.

The light reflecting coating may have a thickness, e.g., corresponding to at most 10 to 12 g/m² for an open area of 30 to 50%.

The light reflecting first side of the poster material may, e.g., be white or metalized, and the light absorbing second side of the poster material may, e.g., be black or dark blue or dark grey.

In an exemplary embodiment of the present invention, the open work fabric includes regularly distributed holes, e.g., over at least 50% of its total area. The holes have a diameter, e.g., of 1 to 5 mm or 1 to 2 mm, and the holes amount to, e.g., 30 to 60% or 30 to 50%, of all the areas with regularly distributed holes.

In an exemplary embodiment of the present invention, the material thickness between proximate holes, or hole paths, respectively, varies by, e.g., at most 20%.

In an adhesion compound comprising an open work fabric as poster material the poster material and/or the carrier material may be provided with (i) at least one auxiliary layer, which may be a translucent or transparent or light absorbing, e.g., black, separation/release layer, and/or a translucent or transparent or light absorbing, e.g., black, protection layer on the second side of the poster material, and/or (ii) a translucent, or transparent, or light reflecting, e.g., white or metalized, auxiliary layer on the first side of the poster and/or carrier material, which improves printability.

Information, printed on the textile may be protected, e.g., by at least one additional layer over the information, in particular one or more protective layers for the degradation of abrasion, for the enhancement of the light fastness/light resistance, for the enhancement of the weather resistance, and/or for the protection from graffiti. In order to retain good image quality, such layer should be, e.g., colorless and fully transparent.

Although the present invention has been described with preferred embodiments, it is to be understood that modifications and variations may be utilized without departing from the spirit and scope of the invention, as those skilled in the art will readily understand. Such modifications and variations are considered to be within the purview and scope of the appended claims and their equivalents.

What is claimed is:

1. An adhesion compound for use in producing non-adhesive and non-adherent posters, the adhesion compound comprising:
at least a poster material with a poster substrate; and
a carrier material separably connected to the poster substrate by an adhesive layer;
wherein the poster material has on a second side a light absorbing surface, the adhesive layer has a better adhesion towards the carrier material than towards the poster material such that after separation of the poster material and the carrier material the adhesive layer remains on the carrier material,
the side of the poster material facing the carrier material is the second side with the light absorbing surface,
the poster material has holes extending from the second surface to the first surface, distributed one of regularly and in a regular pattern, such that in separated form it is see-through from the second side with the light absorbing surface,
wherein the hole size of a given hole at or adjacent the first surface is different than the hole size for the same hole at or adjacent the second surface.

2. The adhesion compound of claim 1, wherein the hole size at or adjacent the first surface is smaller than at or adjacent the second surface.

3. The adhesion compound of claim 1, wherein the poster material has on a first side a light reflecting surface.

4. The adhesion compound of claim 3, wherein the poster material has on a first side a light reflecting surface provided by a light reflecting coating.

5. The adhesion compound of claim 1, wherein the poster substrate is light-absorbing.

6. The adhesion compound of claim 3, wherein the first side of the poster material is provided with indicia.

7. The adhesion compound of claim 1, wherein the poster substrate is a light absorbing textile.

8. A poster material comprising a poster substrate, wherein:
the poster substrate is a textile material at least one of (i) having a light absorbing coating encasing the textile material, and (ii) formed from yarn having a light absorbing coating,
the poster material has on a second side opposite the first side a light absorbing surface,
the textile material has holes distributed one of regularly and in a regular pattern such that the poster material is see-through from the second side with the light absorbing surface.

9. The poster material of claim 8, wherein the yarn has at least a first surface that is essentially flat.

10. The poster material of claim 8, wherein the first side of the poster material is flattened by thermic forming.

11. The poster material of claim 8, wherein the poster material has on a first side a light reflecting coating.

12. The poster material of claim 8, wherein the hole size of a given hole at or adjacent the first surface is different than the hole size for the same hole at or adjacent the second surface.

13. The poster material of claim 8, wherein the first side of the poster material is provided with indicia.

14. The poster material of claim 10, wherein at least one of (i) the light absorbing coating on the textile material is made from a thermoplastic material, and (ii) the light absorbing coating on the yarn is made from a thermoplastic material.

15. The poster material of claim 8, wherein the yarns are fixed to one another at crossing points.

16. The poster material of claim 8, further comprising a carrier material removably adhered to the poster substrate by means of an adhesive layer and such that the side of the poster material facing the carrier material is the second side with the light absorbing surface, the adhesive layer having a better adhesion towards the carrier material than towards the poster substrate such that after separation of the poster substrate and the carrier material the adhesive layer remains on the carrier material.

17. A poster material comprising a poster substrate, wherein:
the poster substrate is a textile material at least one of (i) having a light absorbing coating made from a thermoplastic material encasing the textile material, and (ii) formed from light absorbing yarn made from a thermoplastic material, and (iii) formed from yarn having a light absorbing coating made from a thermoplastic material,
the poster material having on a second side opposite the first side a light absorbing surface,
the textile material having holes distributed one of regularly and in a regular pattern such that the poster material is see-through from the second side with the light absorbing surface,
wherein the yarns are fixed to one another at crossing points.

18. The poster material of claim 17, wherein a first side of the poster material is flattened by thermic forming.

19. The poster material of claim 17, wherein the poster material having on a first side a light reflecting coating.

20. The poster material of claim 17, wherein a first side of the poster material having indicia thereon.
